(19) United States
(12) Patent Application Publication
(10) Pub. No.: US 2020/0339729 A1
(43) Pub. Date: Oct. 29, 2020

(54) METHOD FOR PREPARING MIXED SILANE-TERMINATED POLYMERS

(71) Applicant: Covestro Deutschland AG, Leverkusen (DE)

(72) Inventors: Florian STEMPFLE, Köln (DE); Christoph THIEBES, Köln (DE); Ute NATTKE, Leverkusen (DE); Hans-Josef LAAS, Odenthal (DE)

(21) Appl. No.: 16/957,070

(22) PCT Filed: Dec. 20, 2018
(86) PCT No.: PCT/EP2018/086273

§ 371 Date: Jun. 22, 2020

(30) Foreign Application Priority Data
Dec. 22, 2017 (EP) 17209988.9

(51) Int. Cl. C08G 18/28; C08G 18/10; C08G 18/24; C08G 18/48; C08G 18/71; C08G 18/75; C08G 18/22

(52) U.S. Cl. CPC C08G 18/289; C08G 18/10; C08G 18/246; C08L 75/08; C08G 18/718; C08G 18/755; C08G 18/222; C08G 18/4825

(57) ABSTRACT

The invention relates to a method for preparing a silane-terminated polymer by reacting a polyol A) with a diisocyanate B), an isocyanatosilane C) and an amino silane E), wherein the polyol component A) is reacted simultaneously with a mixture of at least one diisocyanate B) and one isocyanatosilane C), and the resulting product is subsequently reacted with the amino silane E) to produce the silane-terminated polymer. The method according to the invention can be used to prepare mixed silane-terminated polymers having a low viscosity.

The present invention relates to the preparation of mixed silane-terminated polymers having low viscosity by reacting a polyol with a diisocyanate, an isocyanatosilane and an aminosilane.

Silane-terminated polymers refers generally to alkoxysilane-functional polymers, in particular alkoxysilane-functional polyurethanes. Polymers of this kind are used, for example, as moisture-curing one-component polyurethanes in coating compositions, sealants and adhesives, in particular in the construction sector and in the automobile industry.

Various synthesis routes are known for preparing silane-terminated polymers. According to U.S. Pat. No. 3,627,722 A or U.S. Pat. No. 3,632,557 A, for example, amino-functional alkoxysilanes can be reacted with NCO-containing prepolymers, forming a urea group, to give alkoxy-functional polyurethanes. Such alkoxysilane-functional polyurethanes crosslink relatively rapidly and cure to give non-tacky materials with good strength and extensibility. However, such polymers have a high viscosity on account of the urea groups formed during the preparation, which makes the formulation of compositions with good processability markedly more difficult.

According to EP 0 070 475 A2 and U.S. Pat. No. 5,990,257 A, an alternative synthesis route consists in the reaction of NCO-containing alkoxysilanes with hydroxy-functional prepolymers, with the silane group being joined to the polymer to form a urethane group. Examples of hydroxy-functional pre-polymers that may be used here are hydroxy-functional polyurethanes which can be obtained by reaction of diisocyanates with diols, or long-chain diols which have not been pre-extended via a reaction with diisocyanates (EP 0372561 A2). One disadvantage of this synthesis route consists in that the required NCO-containing alkoxysilanes are of only limited storability and are often expensive.

The disadvantages of these two synthesis routes can be compensated by means of a hybrid method which combines both synthesis routes. Such a process is described, for example, in AU 2015100195 A4 and US 2015/0266995 A1. In this case, in a multistep process firstly a portion of the hydroxyl groups of a polyether polyol are reacted with a diisocyanate. In a second step, an aminosilane is added and reacted with the free NCO groups of the polymer obtained in the first step until no free NCO groups are detectable any longer in the reaction mixture. Finally, the hydroxyl groups of the polymer that are still free are reacted with an NCO-containing alkoxysilane. One disadvantage of this process is its inadequate reproducibility. For instance, in the first reaction step, the reaction of the free NCO groups of the diisocyanate with the hydroxyl groups of the polyol that are present in excess can be controlled only with difficulty. The incomplete conversion is therefore often not—as desired per se—achieved, and under some circumstances there is an undesired pre-extension, in that two diols react with one diisocyanate molecule to give a long-chain polymer. This leads to a broadening of the molecular weight distribution of the silane-terminated polymer towards a higher mean molecular weight and hence to an undesirable increase in the viscosity. In addition, in the process described the aminosilane is in the presence of the free hydroxyl groups of the polymer. As a result, there may likewise be an undesired increase in the molecular weight via silane condensation, which also has a negative effect on the obtained viscosity of the end product. In order to achieve the low viscosity required for use as coating compositions, sealants and adhesives, the addition of plasticizers is in this case therefore necessary.

According to US 2015/0266995 A1, a portion of the hydroxyl groups of a polyether polyol may also be reacted with the NCO-containing alkoxysilane before addition of the diisocyanate. The polymers described in this document are indeed also referred to as mixed silane-terminated polymers since they contain both silane groups which are joined to the polymer backbone via urea groups and also those silane groups which are joined to the polymer backbone via urethane groups. However, the publication lacks specific teaching with regard to the technical activity, that is to say lacks clear instructions or at least indications regarding the precise configuration of this procedure.

Besides the inadequate reproducibility, a further disadvantage of the hybrid method consists in that it is composed of a multiplicity of reaction steps, which drives up the costs of the process. Against this background, it is an object of the present invention to provide a simplified process for preparing mixed silane-terminated polymers which reliably and reproducibly affords polymers having a narrow molecular weight distribution and a low viscosity.

This object has been achieved with the provision of the process described in more detail hereafter.

The present invention is based on the surprising observation that mixed silane-terminated polymers featuring lower viscosities than those obtained by the processes of the prior art can be obtained in a very simple manner via simultaneous reaction of polyols with a diisocyanate and an isocyanatosilane and subsequent reaction of the obtained isocyanate-functional intermediate with an aminosilane. These silane-terminated polymers are referred to as “mixed” silane-terminated polyols since they contain both silane groups which are joined to the polymer backbone via urea groups and also those silane groups which are joined to the polymer backbone via urethane groups.

The present invention therefore provides a process for preparing a mixed silane-terminated polymer by
a) simultaneously reacting the hydroxyl groups of a polyol component A) with at least one diisocyanate B) and at least one isocyanatosilane C) in the presence of at least one catalyst D),
   and
b) subsequently reacting the free NCO groups of the reaction product from step a) with an aminosilane E).

The invention also provides the mixed silane-terminated polymers obtainable by this process and also the use thereof as binders in coating compositions, in particular in coating material, sealant or adhesive raw materials.

Advantageous developments are specified in the dependent claims. They may be freely combined, unless the opposite is clearly evident from the context.

The polyol components A) used in the process according to the invention are any desired polyols, for example the polymeric polyether polyols, polyester polyols, polycarbonate polyols, polyurethane polyols and/or polyacrylate polyols known from polyurethane chemistry. These generally have an average functionality of 1.8 to 6, preferably of 1.8 to 4, particularly preferably of 1.9 to 2.2. The number-average molecular weight (determined according to DIN 55672-1:2016-03) of these polyols, preferably polyether polyols, is generally from 3000 to 24 000 g/mol, preferably from 5000 to 16 000 g/mol, particularly preferably from 7000 to 12 000 g/mol. It is also possible to use any desired mixtures of such polyols.

Typically, the polyol components A) have OH numbers, determined according to DIN 53240, of at least 4.5 mg KOH/mg. The OH number is preferably in the range from 8 to 30 mg KOH/g, particularly preferably from 8 to 20 mg KOH/g, most preferably from 9 to 18 mg KOH/g.

Preferred polyol components A) for the process according to the invention are polyether polyols, for example those of the type specified in DE 26 22 951 B, column 6 line 65 to column 7 line 26, EP-A 0 978 523, page 4 line 45 to page 5 line 14, or WO 2011/069 966, page 4 line 20 to page 5 line 23, provided that they meet the specifications made above in terms of functionality and molecular weight. Polyether polyols that are particularly preferred as polyol components A) are addition products of ethylene oxide and/or propylene oxide onto propane-1,2-diol, propane-1,3-diol, glycerol, trimethylolpropane, ethylenediamine and/or pentaerythritol, or the polytetramethylene ether glycols of the molecular weight range specified above which are obtainable by polymerizing tetrahydrofuran, for example according to Angew. Chem. 72, 927 (1960).

Very particularly preferred polyol components A) are polyether polyols based on polypropylene oxide, such as are commercially available for example from Covestro Deutschland AG under the Acclaim® trade name, for example Acclaim® 8200 N.

The diisocyanates B) used in the process according to the invention are any desired diisocyanates which have aliphatically, cycloaliphatically, araliphatically and/or aromatically bonded isocyanate groups and can be prepared by any desired processes, for example by phosgenation or by a phosgene-free route, for example by urethane cleavage.

Preferred diisocyanates B) are those of the general formula (I)

OCN—Y—NCO (I)

in which Y is a linear or branched, aliphatic or cycloaliphatic radical having 4 to 18 carbon atoms or an optionally substituted aromatic or araliphatic radical having 6 to 18 carbon atoms.

Suitable examples are, for example, 1,4-diisocyanatobutane, 1,6-diisocyanatohexane (HDI), 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), hexahydrotolylene 2,4- and/or 2,6-diisocyanate (H6-TDI),1-isocyanato-1-methyl-4(3)-isocyanatomethylcyclohexane, 2,4′- and 4,4′-diisocyanatodicyclohexylmethane (H12-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (XDI), 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate (TDI) and any desired mixtures of these isomers, diphenylmethane 2,4′- and/or 4,4′-diisocyanate (MDI) and naphthylene 1,5-diisocyanate (NDI) and any desired mixtures of such diisocyanates.

Particularly preferred starting components B) are diisocyanates of the general formula (I) in which Y is a linear or branched, aliphatic or cycloaliphatic radical having 6 to 13 carbon atoms.

Particularly preferred diisocyanates B) for the process according to the invention are 1,6-diisocyanatohexane, 1-isocyanato-3,3,5-trimethyl-5-isocyanatomethylcyclohexane, hexahydrotolylene 2,4- and 2,6-diisocyanates and tolylene 2,4- and 2,6-diisocyanate or mixtures thereof.

In a very particularly preferred embodiment, the diisocyanate B) used is 1-isocyanato-3,3,5-trimethyl-5-isocyanatomethylcyclohexane (isophorone diisocyanate).

The isocyanatosilanes C) used in the process according to the invention are any desired compounds in which at least one, preferably precisely one, isocyanate group and at least one, preferably precisely one, silane group having at least one alkoxy substituent are simultaneously present alongside one another. The isocyanatosilanes C) are also referred to hereafter as alkoxysilane-functional isocyanates C) or as isocyanatoalkoxysilanes C).

Examples of suitable isocyanatoalkoxysilanes C) are isocyanatoalkylalkoxysilanes as are obtainable, for example, by the processes described in U.S. Pat. No. 3,494,951-B, EP-A 0 649 850, WO 2014/063 895 and WO 2016/010 900 via a phosgene-free route by means of thermal cleavage of the corresponding carbamates or ureas.

In a further preferred embodiment, the alkoxysilane-functional isocyanate (isocyanatosilane) C) used is at least one compound of general formula (II)

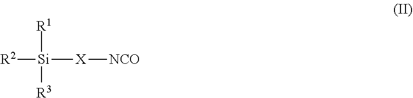

in which
R¹, R² and R³ independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably in each case alkyl radicals which have up to 6 carbon atoms and/or alkoxy radicals which have up to 6 carbon atoms and may contain up to 3 oxygen atoms, particularly preferably in each case methyl, methoxy and/or ethoxy, with the proviso that at least one of the radicals R¹, R² and R³ is joined to the silicon atom via an oxygen atom, and
X is a linear or branched organic radical having up to 6, preferably 1 to 4, carbon atoms, particularly preferably a propylene radical (—CH₂—CH₂—CH₂—).

Examples of such isocyanatoalkoxysilanes include isocyanatomethyltrimethoxysilane, (isocyanatomethyl)methyldimethoxysilane, isocyanatomethyltriethoxysilane, (isocyanatomethyl)methyldiethoxysilane, isocyanatomethyltriisopropoxysilane, 2-isocyanatoethyltrimethoxysilane, 2-isocyanatoethyltriethoxysilane, 2-isocyanatoethyltriisopropoxysilane, 3-isocyanatopropyltrimethoxysilane, 3-isocyanatopropyltriethoxysilane, 3-isocyanatopropylmethyldimethoxysilane, 3-isocyanatopropylmethyldiethoxysilane, 3-isocyanatopropylethyldiethoxysilane, 3-isocyanatopropyldimethylethoxysilane, 3-isocyanatopropyldiisopropylethoxysilane, 3-isocyanatopropyltripropoxysilane, 3-isocyanatopropyltriisopropoxysilane, 3-isocyanatopropyltributoxysilane, 3-isocyanatopropylmethyldibutoxysilane, 3-isocyanatopropylphenyldimethoxysilane, 3-isocyanatopropylphenyldiethoxysilane, 3-isocyanatopropyltris(methoxyethoxyethoxy)silane, 2-isocyanatoisopropyltrimethoxysilane, 4-isocyanatobutyltrimethoxysilane, 4-isocyanatobutyltriethoxysilane, 4-isocyanatobutyltriisopropoxysilanes, 4-isocyanatobutylmethyldimethoxysilane, 4-isocyanatobutylmethyldiethoxysilane, 4-isocyanatobutylethyldimethoxysilane, 4-isocyanatobutylethyldiethoxysilane, 4-isocyanatobutyldimethylmethoxysilane, 4-isocyanatobutylphenyldimethoxysilane, 4-isocyanatobutylphenyldiethoxysilane, 4-isocyanato(3-methylbutyl)trimethoxysilane, 4-isocyanato(3-methylbutyl)triethoxysilane, 4-isocyanato(3-methylbutyl)methyldimethoxysilane, 4-isocyanato(3-methylbutyl)methyldiethoxysilane and 11-isocyanatoundecyltrimethoxysilane or any desired mixtures of such isocyanatoalkoxysilanes.

Preferred isocyanatosilanes C) are in particular isocyanatomethyltrimethoxysilane, isocyanatomethyltriethoxysilane, (isocyanatomethyl)methyldimethoxysilane, (isocyanatomethyl)methyldiethoxysilane, 3-isocyanatopropyltrimethoxysilane, 3-isocyanatopropylmethyldimethoxysilane, 3-isocyanatopropyltriethoxysilane and 3-isocyanatopropylmethyldiethoxysilane. Particular preference is given to the use of 3-isocyanatopropyltrimethoxysilane.

The molar amounts of diisocyanate B) and isocyanatosilane C) used in the process according to the invention are guided by the molar amount of hydroxyl groups of polyol component A) and the desired ratio of isocyanatosilane C) to diisocyanate B). The total molar amount of isocyanatosilane C) and diisocyanate B) is preferably selected such that the hydroxyl groups of the polyol are completely converted to urethane groups and an isocyanate- and silane-functional polymer is formed.

In order to make the process according to the invention as cost-effective as possible, it is advantageous to minimize the proportion of isocyanatosilane C). Preferably, the molar amount of isocyanatosilane C) used is accordingly at most 50 mol % based on the number of hydroxyl groups of polyol component A). In general, the molar amount of isocyanatosilane C) used in the process according to the invention is in the range from 1 to 50 mol %, preferably in the range from 5 to 28 mol%, particularly preferably in the range from 10 to 28 mol %, very particularly preferably in the range from 10 to 25 mol %, in each case based on the number of hydroxyl groups of polyol A).

Depending on the chosen molar amount of isocyanatosilane C), diisocyanate B) is generally used in the process according to the invention in a molar amount of 50 to 99 mol %, preferably of 72 to 95 mol %, particularly preferably of 72 to 90 mol %, very particularly preferably in a molar amount of 75 to 90 mol %, in each case based on the number of hydroxyl groups of polyol A).

The reaction of polyol component A) with diisocyanate B) and isocyanatosilane C) is effected in step a) of the process according to the invention in the presence of a catalyst D).

Suitable catalysts D) are any desired urethanization catalysts customary in isocyanate chemistry, provided that they do not accelerate the silane condensation as well. Examples include tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylene-triamine, N-methylpiperidine, N-dimethylaminoethylpiperidine, N,N′-dimethylpiperazine, N-methyl-N′-dimethylaminopiperazine, 1,2-dimethylimidazole, 2-methylimidazole, N,N-dimethylimidazole-β-phenylethylamine, 1,4-diazabicyclo[2.2.2]octane (DABCO) and bis(N,N-dimethylaminoethyl) adipate, amidines, for example 1,5-diazabicyclo[4.3.0]nonene (DBN), 1,8-diazabicyclo[5.4.0]undec-7-ene (DBU) and 2,3-dimethyl-3,4,5,6-tetrahydropyrimidine, alkanolamine compounds, for example triethanolamine, triisopropanolamine, N-methyldiethanolamine, N-ethyldiethanolamine, dimethylaminoethanol and 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine, bis(dimethylaminoethyl) ether and metal salts, for example inorganic and/or organic compounds of iron, lead, bismuth, zinc and/or tin in customary oxidation states of the metal, for example iron(II) chloride, iron(III) chloride, bismuth(III) bismuth(III) 2-ethylhexanoate, bismuth(III) octoate, bismuth(III) neodecanoate, ytterbium(III) chloride, zinc chloride, zinc 2-ethylcaproate, tin(II) acetate, tin(II) ethylcaproate, tin(II) laurate, tin(II) octoate, tin(II) palmitate, dibutyltin(IV) dilaurate (DBTL), dibutyltin(IV) diacetate, dibutyltin(IV) dichloride or lead octoate.

Examples of further suitable catalysts are also organotitanates, and β-diketonate compounds of the transition metals scandium, lanthanum, cerium, praseodymium, neodymium, promethium, samarium, europium, gadolinium, terbium, dysprosium, holmium, erbium, thulium, ytterbium and lutetium.

Catalysts D) used in the process according to the invention are preferably Sn-, Ti- or Yb-containing compounds.

Particularly suitable tin-containing catalysts D) are by way of example Sn(II) salts of organic carboxylic acids and dialkyl-Sn(IV) salts of organic carboxylic acids, with dialkyl-Sn(IV) salts of organic carboxylic acids being very particularly preferred. Suitable organic carboxylic acids are in particular linear or branched, aliphatic mono- or dicarboxylic acids having 2 to 16 carbon atoms, preferably 2 to 12 carbon atoms. Suitable dialkyl-Sn(IV) compounds comprise preferably linear or branched alkyl groups in each case having 1 to 12 carbon atoms, particularly preferably 4 to 8 carbon atoms.

In a very particularly preferred embodiment, the Sn-containing catalyst is selected from tin(II) acetate, tin(II) ethylcaproate, tin(II) laurate, tin(II) octoate, tin(II) palmitate, dibutyltin(IV) dilaurate (DBTL), dibutyltin(IV) diacetate, dibutyltin(IV) dichloride, or mixtures thereof.

Particularly suitable titanium-containing catalysts D) are for example organotitanates. The term organotitanate refers in the present document to compounds which have at least one ligand bonded to the titanium via an oxygen atom. Suitable organotitanates have ligands which are selected from the group consisting of alkoxy group, sulfonate group, carboxylate group, dialkylphosphate group, dialkylpyrophosphate group and acetylacetonate group, where all ligands may be identical or different from each other.

What are known as neoalkoxy substituents, in particular of formula (III), have proven to be particularly suitable alkoxy groups in particular.

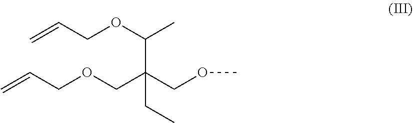

In particular, aromatic sulfonic acids the aromatic systems of which have been substituted by an alkyl group have proven to be particularly suitable sulfonic acids. Preferred sulfonic acids are radicals of formula (IV).

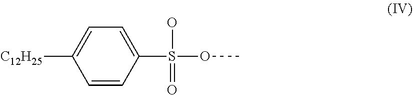

In particular, carboxylates of fatty acids have proven to be particularly suitable carboxylate groups. Preferred carboxylates are decanoate, stearate and isostearate.

In particular, the catalyst has at least one polydentate ligand, also called chelating ligand. The polydentate ligand is in particular a bidentate ligand.

The bidentate ligand is preferably a ligand of formula (V)

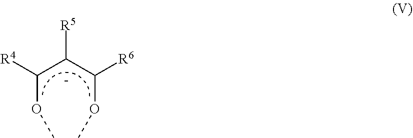

Here, radical R⁴ is a hydrogen atom or a linear or branched alkyl group having 1 to 8 carbon atoms, in particular is a methyl group. Radical R⁵ is a hydrogen atom or a linear or branched alkyl group having 1 to 8 carbon atoms and optionally having heteroatoms, in particular is a hydrogen atom.

Radical R⁶ is a hydrogen atom or an alkyl group having 1 to 8, in particular having 1 to 3, carbon atoms or a linear or branched alkoxy group having 1 to 8, in particular having 1 to 3, carbon atoms.

The titanium-containing catalyst D) is preferably an organotitanate, in particular an organotitanate of formula (VI).

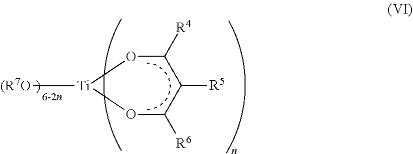

The radicals R⁴, R⁵ and R⁶ have already been described above. The radical R⁷ is a linear or branched alkyl radical having 2 to 20 carbon atoms, in particular is an isobutyl or an isopropyl radical. n is a value of 1 or 2, in particular 2.

Preference is given to organotitanates of formula (VI), where the radical R⁴ is a methyl group, the radical R⁵ is a hydrogen atom, the radical R⁶ is a methyl group or methoxy or ethoxy group and the radical R⁷ is an isobutyl or an isopropyl radical.

Suitable organotitanates are for example commercially available under the Tyzor® AA, GBA, GBO, AA-75, AA-65, AA-105, DC, BEAT, IBAY trade names from DuPont, USA, or under the Tytan™ PBT, TET, X85, TAA, ET, S2, S4 or S6 trade names from TensoChema AG, Switzerland.

In an alternative embodiment, the catalyst D) used is a β-diketonate compound of the transition metals scandium, lanthanum, cerium, praseodymium, neodymium, promethium, samarium, europium, gadolinium, terbium, dysprosium, holmium, erbium, thulium, ytterbium or lutetium. This β-diketonate compound is based on the mentioned metals preferably in the main oxidation states +III or +IV thereof. Particular preference is given to β-diketonate compounds based on Yb(III).

β-Diketonate compounds of the metals defined above are understood to be all compounds of these metals having at least one ligand or substituent which has been derived from a β-diketone by anion formation, preferably by deprotonation, and consequently has one or more structural units of formula (VII).

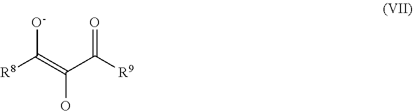

R⁸, R⁹ independently of one another here are identical or different, optionally heteroatom-containing organic radicals having preferably in each case 1-20, particularly preferably 1-10 carbon atoms.

The β-diketonate compounds used preferably have exclusively ligands/substituents of the β-diketonate type.

One particularly preferred β-diketonate is acetylacetone (‘acac’). Very particular preference is given here to the use of Yb(acac)₃ as catalyst.

It is in addition also possible that the catalysts D) according to the invention contain water of crystallization.

Particular preference is given to titanium- or ytterbium-containing catalysts of the type mentioned.

In the process according to the invention, the catalysts D) can be used individually or in the form of any desired mixtures with one another and are used in this case in amounts of 0.001% to 1% by weight, preferably 0.01% to 0.5% by weight, calculated as the total weight of catalysts used based on the total weight of the coreactants A), B) and C).

In the process according to the invention, the isocyanate groups of the isocyanate- and silane-functional polymer obtained in step a) are reacted in a second step b) with an aminosilane E).

Examples of aminosilanes E) that are suitable for this purpose are aminosilanes of general formula (VIII)

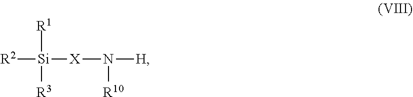

in which

R¹, R², R³ and X have the definition given for formula (II)

and

R¹⁰ is hydrogen, a saturated or unsaturated, linear or branched, aliphatic or cycloaliphatic or an optionally substituted aromatic or araliphatic radical having up to 18 carbon atoms or a radical of the formula

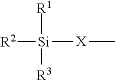

in which R¹, R², R³ and X have the definition given above.

Suitable aminosilanes of general formula (VIII) are for example 3-aminopropyltrimethoxysilane, 3-aminopropyltriethoxysilane, 3-aminopropylmethyldimethoxysilane, 3-aminopropylmethyldiethoxysilane, 3-aminopropylethyldiethoxysilane, 3-aminopropyldimethylethoxysilane, 3-aminopropyldiisopropylethoxysilane, 3-aminopropyltripropoxysilane, 3-aminopropyltributoxysilane, 3-aminopropylphenyldiethoxysilane, 3-aminopropylphenyldimethoxysilane, 3-aminopropyltris(methoxyethoxyethoxy)silane, 2-aminoisopropyltrimethoxysilane, 4-aminobutyltrimethoxysilane, 4-aminobutyltriethoxysilane, 4-aminobutylmethyldimethoxysilane, 4-aminobutylmethyldiethoxysilane, 4-aminobutylethyldimethoxysilane, 4-aminobutylethyldiethoxysilane, 4-aminobutyldimethylmethoxysilane, 4-aminobutylphenyldimethoxysilane, 4-aminobutylphenyldiethoxysilane, 4-amino(3-methylbutyl)methyldimethoxysilane, 4-amino(3-methylbutyl)methyldiethoxysilane, 4-amino(3-methylbutyl)trimethoxysilane, 3-aminopropylphenylmethyl-n-propoxysilane, 3-aminopropylmethyldibutoxysilane, 3-aminopropyldiethylmethylsilane, 3-aminopropylmethylbis(trimethylsiloxy)silane, 11-aminoundecyltrimethoxysilane, N-methyl-3-aminopropyltrimethoxysilane, N-methyl-3-aminopropyltriethoxysilane, N-(n-butyl)-3-aminopropyltrimethoxysilane, N-(n-butyl)-3-aminopropyltriethoxysilane, N-(2-aminoethyl)-3-aminopropyltrimethoxysilane, N-(2-aminoethyl)-3-aminoisobutylmethyldimethoxysilane, N-(2-aminoethyl)-3-aminopropylmethyldimethoxysilane, N-(2-aminoethyl)-3-aminopropyltris(2-ethylhexoxy)silane, N-(6-aminohexyl)-3-aminopropyltrimethoxysilane, N-benzyl-N-(2-aminoethyl)-3-aminopropyltrimethoxysilane, bis(3-trimethoxysilylpropyl)amine, bis(3-triethoxysilylpropyl)amine, (aminoethylaminomethyl)phenethyltrimethoxysilane, N-vinylbenzyl-N-(2-aminoethyl)-3-aminopropylpolysiloxane, N-vinylbenzyl-N-(2-aminoethyl)-3-aminopropylpolysiloxane, 3-ureidopropyltriethoxysilane, 3-(m-aminophenoxy)propyltrimethoxysilane, m- and/or p-aminophenyltrimethoxysilane, 3-(3-aminopropoxy)-3,3-dimethyl-1-propenyltrimethoxysilane, 3-aminopropylmethylbis(trimethylsiloxy)silane, 3-aminopropyltris(trimethylsiloxy)silane, 3-aminopropylpentamethyldisiloxane or any desired mixtures of such aminosilanes.

Preferred aminosilanes of the general formula (VIII) are those in which
R¹, R² and R³ are each alkyl radicals having up to 6 carbon atoms and/or alkoxy radicals which contain up to 3 oxygen atoms, with the proviso that at least one of the radicals R¹, R² and R³ is an alkoxy radical of this kind,
X is a linear or branched alkylene radical having 3 or 4 carbon atoms, and
R¹⁰ is a saturated linear or branched, aliphatic or cycloaliphatic radical having up to 6 carbon atoms or a radical of the formula

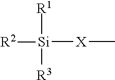

in which R¹, R², R³ and X have the definition given above.

Particularly preferred aminosilanes of the general formula (VIII) are those in which
R¹, R² and R³ are each methyl, methoxy and/or ethoxy, with the proviso that at least one of the radicals R¹, R² and R³ is a methoxy or ethoxy radical,
X is a propylene radical (—CH₂—CH₂—CH₂—), and
R¹⁰ is a linear alkyl radical having up to 4 carbon atoms or a radical of the formula

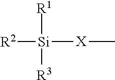

in which R¹, R², R³ and X have the definition given above.

Very particularly preferred aminosilanes of the general formula (VIII) are N-methyl-3-aminopropyltrimethoxysilane, N-methyl-3-aminopropyltriethoxysilane, N-(n-butyl)-3-aminopropyltrimethoxysilane, N-(n-butyl)-3-aminopropyltriethoxysilane, bis(3-trimethoxysilylpropyl)amine and/or bis(3-triethoxysilylpropyl)amine.

Suitable aminosilanes E) are, for example, also those of the general formula (IX)

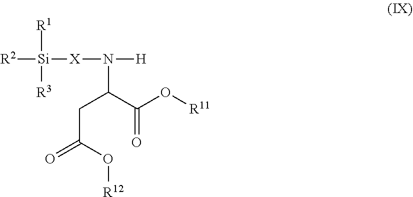

in which R¹, R² and R³ have the definition given for formula (II),
X is a linear or branched organic radical having at least 2 carbon atoms and
R¹¹ and R¹² independently of one another are saturated or unsaturated, linear or branched, aliphatic or cycloaliphatic or aromatic organic radicals which have 1 to 18 carbon atoms, are substituted or unsubstituted and/or have heteroatoms in the chain.

These aminosilanes of the general formula (IX) are the silane-functional aspartic esters obtainable according to the teaching of EP-A 0 596 360 by reacting aminosilanes bearing primary amino groups with fumaric esters and/or maleic esters.

Suitable starting compounds for preparation of aminosilanes of the general formula (IX) are there- fore, in principle, any aminosilanes of the general formula (X)

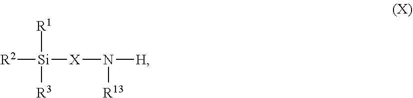

in which R¹, R², R³ and X have the definition given for formula (II) and R¹³ is hydrogen.

These are reacted with fumaric diesters and/or maleic diesters of the general formula (XI)

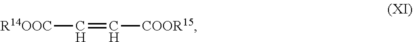

in which the radicals R¹⁴ and R¹⁵ are identical or different radicals and are organic radicals having 1 to 18, preferably 1 to 9, particularly preferably 1 to 4, carbon atoms.

Preferred aminosilanes of the general formula (IX) are reaction products of aminosilanes of the general formula (VIII) in which
R¹, R² and R³ are each methyl, methoxy and/or ethoxy, with the proviso that at least one of the radicals R¹, R² and R³ is a methoxy or ethoxy radical,
X is a propylene radical (—CH₂—CH₂—CH₂—), and
R¹⁰ is hydrogen,
   with
   fumaric diesters and/or maleic diesters of the general formula (XI) in which the radicals R¹⁴ and R¹⁵ are identical or different radicals and are a methyl, ethyl, n-butyl or 2-ethylhexyl radical.

Particularly preferred aminosilanes of the general formula (IX) are reaction products of 3-aminopropyltrimethoxysilane and/or 3-aminopropyltriethoxysilane with diethyl maleate.

Suitable aminosilanes E) are, for example, also those of the general formula (XII)

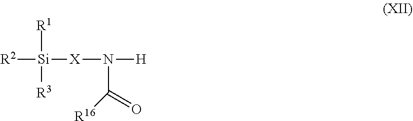

in which R¹, R² and R³ have the definition given for formula (II),
X is a linear or branched organic radical having at least 2 carbon atoms and
R¹⁶ is a saturated linear or branched, aliphatic or cycloaliphatic organic radical having 1 to 8 carbon atoms.

These aminosilanes of the general formula (XII) are the known silane-functional alkylamides as obtainable, for example, by the methods disclosed in U.S. Pat. No. 4,788,310 and U.S. Pat. No. 4,826,915, by reacting aminosilanes bearing primary amino groups with alkyl alkylcarboxylates with elimination of alcohol.

Suitable starting compounds for preparation of aminosilanes of the general formula (XII) are therefore, in principle, any aminosilanes of the general formula (XIII)

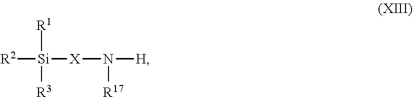

in which R¹, R², R³ and X have the definition given for formula (II) and R¹⁷ is hydrogen.

These are reacted with alkyl alkylcarboxylates of the general formula (XIV)

R¹⁸—COOR¹⁹ (XIV),

in which
R¹⁸ is hydrogen or a saturated linear or branched, aliphatic or cycloaliphatic organic radical having 1 to 8 carbon atoms and
R¹⁹ is a saturated aliphatic organic radical having 1 to 4 carbon atoms.

Preferred aminosilanes of the general formula (XII) are reaction products of aminosilanes of the general formula (VIII) in which
R¹, R² and R³ are each methyl, methoxy and/or ethoxy, with the proviso that at least one of the radicals R¹, R² and R³ is a methoxy or ethoxy radical,
X is a propylene radical (—CH₂—CH₂—CH₂—), and
R⁴ is hydrogen,
   with
   alkyl formates of the general formula (XIV) in which
R¹⁸ is hydrogen and
R¹⁹ is a saturated aliphatic organic radical having 1 to 4 carbon atoms.

Particularly preferred aminosilanes E) of the general formula (IV) are reaction products of 3-aminopropyltrimethoxysilane and/or 3-aminopropyltriethoxysilane with methyl formate and/or ethyl formate.

The amount of aminosilane E) is very particularly preferably chosen such that an isocyanate group-free product is formed in process step b). To this end, when performing the process according to the invention in practice the amount of aminosilane E) is generally chosen such that there are from 0.8 to 1.2, preferably from 0.9 to 1.1, particularly preferably from 0.95 to 1.05 amino groups for each isocyanate group of the isocyanate- and silane-functional polymer formed in process step a).

For the performance of the process according to the invention, in a first step a) the polyol component A) is reacted simultaneously with the diisocyanate B) and the isocyanatosilane C).

In one possible embodiment, in the process according to the invention the polyol component A), optionally under an inert gas such as for example nitrogen, is initially charged at a temperature between 20 and 100° C. Subsequently, the diisocyanate B) and the isocyanatosilane C) are simultaneously added in parallel in the amount specified above and the temperature of the reaction mixture is adjusted optionally by an appropriate measure (heating or cooling) to 30° C. to 120° C., preferably of 50° C. to 100° C. In another embodiment of the process according to the invention, the diisocyanate B) and the isocyanatosilane C) are blended in a preceding step to form a homogeneous isocyanate component and are metered into the polyol component A) as a mixture under the conditions given above.

Irrespective of this, the catalyst D) to be jointly used may already be admixed in the amount specified above with one or more of the coreactants, the polyol component A), the diisocyanate B) and/or the isocyanatosilane C), or with a mixture of components B) and C), prior to the start of the actual reaction. However, the catalyst D) can also be added to the reaction mixture at any desired point in time during the metered addition or thereafter.

The progress of the reaction can be monitored by determining the NCO content by titrimetric means, for example.

After complete reaction of the hydroxyl groups of polyol component A), in a second reaction step b) the aminosilane E) is metered in. The reaction with the free isocyanate groups is effected at a temperature of the reaction mixture of 30° C. to 120° C., preferably of 50° C. to 100° C., which is optionally set by an appropriate measure (heating or cooling).

Irrespective of the nature and amount of the starting compounds A) to E) used, the obtained products of the process according to the invention are clear, virtually colorless mixed silane-terminated polymers which generally have color numbers of below 120 APHA, preferably of below 80 APHA, particularly preferably of below 60 APHA, and are outstandingly suitable as binders for coating material, sealant or adhesive raw materials.

The mixed silane-terminated polymers prepared with the process according to the invention are particularly suitable as moisture-curing adhesives with exceptional long-term stability and good processability. On account of their low viscosity, they render the addition of plasticizers superfluous. The silane-terminated polymers can in particular be used as adhesives on porous substrates.

### EXAMPLES

All reported percentages are based on weight unless otherwise stated.

The NCO contents were determined by titrimetry according to DIN EN ISO 11909.

OH numbers were determined by titrimetry according to DIN 53240 T.2.

All viscosity measurements were made with a Physica MCR 51 rheometer from Anton Paar Germany GmbH (Germany) to DIN EN ISO 3219.

The Hazen color number was measured by spectrophotometry according to DIN EN ISO 6271-2:2004 with a LICO 400 spectrophotometer from Lange, Germany.

The reported molecular weights are in each case number-average molecular weights (Mn) which can be determined by gel permeation chromatography.

For the practical performance of the following examples, it should be noted that the contents in the substances used of the groups that are relevant to the respective reaction (e.g. amine content of the aminosilane) have been determined by specific determination methods (e.g. titration) and the amounts actually used have been calculated on the basis of contents of in each case 100%.

### Example 1 (Comparative Example)

In a 2 l sulfonation flask with lid, stirrer, thermometer and nitrogen flow, 1367.7 g (0.16 mol) of a propylene glycol with an OH number of 13.4 (Acclaim® Polyol 8200 N from Covestro Deutschland AG; Leverkusen, Germany) were stirred with 35.3 g (0.16 mol) of 3-isocyanatopropyltrimethoxysilane (Geniosil® GF 40 from Wacker Chemie AG; Munich, Germany) at 60° C. with addition of 160 ppm of Valikat® Bi 2810 (bismuth(III) neodecanoate) (Umicore Specialty Materials, Bruges, Belgium) until it was no longer possible to observe any isocyanate band in the IR spectrum. Subsequently, 36.3 g (0.16 mol) of isophorone diisocyanate was rapidly added dropwise and prepolymerization was effected until the theoretical NCO content of 0.47% had been reached. After addition of 56.2 g (0.16 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that was thus obtained had a viscosity of 18 600 mPas and a color number of 28 APHA.

### Example 2 (According to the Invention)

In a 2 l sulfonation flask with lid, stirrer, thermometer and nitrogen flow, 1367.7 g (0.16 mol) of a propylene glycol with an OH number of 13.4 (Acclaim® Polyol 8200 N from Covestro Deutschland AG; Leverkusen, Germany) were prepolymerized with 36.3 g (0.16 mol) of isophorone diisocyanate and 35.3 g (0.16 mol) of 3-isocyanatopropyltrimethoxysilane (Geniosil® GF 40 from Wacker Chemie AG; Munich, Germany) at 60° C. with addition of 160 ppm of Valikat® Bi 2810 (bismuth(III) neodecanoate) (Umicore Specialty Materials, Bruges, Belgium) until the theoretical NCO content of 0.47% had been reached. Subsequently, 56.2 g (0.16 mol) of diethyl N-(3-trimethoxysilylpropyl)aspartate (prepared according to EP-A 596 360, example 5) were rapidly added dropwise and the mixture was stirred until it was no longer possible to observe any isocyanate band in the IR spectrum. The polyurethane prepolymer having alkoxysilyl end groups that was obtained had a viscosity of 30 900 mPas and a color number of 26 APHA.

### Example 3 (Comparative Example)

In a 2 l sulfonation flask with lid, stirrer, thermometer and nitrogen flow, 1369.3 g (0.16 mol) of a propylene glycol with an OH number of 13.2 (Acclaim® Polyol 8200 N from Covestro Deutschland AG; Leverkusen, Germany) were stirred with 34.2 g (0.16 mol) of 3-isocyanatopropyltrimethoxysilane (Geniosil® GF 40 from Wacker Chemie AG; Munich, Germany) at 60° C. with addition of 40 ppm of dibutyltin dilaurate until it was no longer possible to observe any isocyanate band in the IR spectrum. Subsequently, 35.8 g (0.16 mol) of isophorone diisocyanate were rapidly added dropwise and prepolymerization was effected until the theoretical NCO content of 0.47% had been reached. After addition of 56.2 g (0.16 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that was obtained had a viscosity of 13 600 mPas and a color number of 18 APHA.

### Example 4 (Comparative Example)

In a 2 l sulfonation flask with lid, stirrer, thermometer and nitrogen flow, 1369.3 g (0.16 mol) of a propylene glycol with an OH number of 13.2 (Acclaim® Polyol 8200 N from Covestro Deutschland AG; Leverkusen, Germany) were prepolymerized with 35.8 g (0.16 mol) of isophorone diisocyanate at 60° C. with addition of 40 ppm of dibutyltin dilaurate until the theoretical NCO content of 0.47% had been reached. After addition of 56.2 g (0.16 mol) of diethyl N-(3-trimethoxysilylpropyl)aspartate (prepared according to EP-A 596 360, example 5), the mixture was stirred until it was no longer possible to observe any isocyanate band in the IR spectrum. Thereafter, 34.2 g (0.16 mol) of 3-isocyanatopropyltrimethoxysilane (Geniosil® GF 40 from Wacker Chemie AG; Munich, Germany) were rapidly added dropwise and the mixture was stirred again until it was no longer possible to observe any isocyanate band in the IR spectrum. The polyurethane prepolymer having alkoxysilyl end groups that was obtained had a viscosity of 13 000 mPas and a color number of 20 APHA.

### Example 5 (According to the Invention)

In a 2 l sulfonation flask with lid, stirrer, thermometer and nitrogen flow, 1369.3 g (0.16 mol) of a propylene glycol with an OH number of 13.2 (Acclaim® Polyol 8200 N from Covestro Deutschland AG; Leverkusen, Germany) were prepolymerized with 35.8 g (0.16 mol) of isophorone diisocyanate and 34.2 g (0.16 mol) of 3-isocyanatopropyltrimethoxysilane (Geniosil® GF 40 from Wacker Chemie AG; Munich, Germany) at 60° C. with addition of 40 ppm of dibutyltin dilaurate until the theoretical NCO content of 0.47% had been reached. Subsequently, 56.2 g (0.16 mol) of diethyl N-(3-trimethoxysilylpropyl)aspartate (prepared according to EP-A 596 360, example 5) were rapidly added dropwise and the mixture was stirred until it was no longer possible to observe any isocya- nate band in the IR spectrum. The polyurethane prepolymer having alkoxysilyl end groups that was obtained had a viscosity of 12 900 mPas and a color number of 16 APHA.

These examples show that silane-terminated polymers having a low viscosity can be obtained by means of the simplified process according to the invention as per example 5. Surprisingly, the polymers prepared in accordance with the invention do not differ substantially in terms of their viscosity from those that have been prepared by means of the processes known from the prior art (examples 3 and 4). It was thus shown that it is possible by way of the process according to the invention to prepare silane-terminated polymers in only two reaction steps, without the viscosity of the polymers being impaired, that is to say rising.

### Example 6 (Comparative Example)

In a 2 l sulfonation flask with lid, stirrer, thermometer and nitrogen flow, 1349.7 g (0.16 mol) of a propylene glycol with an OH number of 13.3 (Acclaim® Polyol 8200 N from Covestro Deutschland AG; Leverkusen, Germany) were stirred with 18.9 g (0.089 mol) of 3-isocyanatopropyltrimethoxysilane (Geniosil® GF 40 from Wacker Chemie AG; Munich, Germany) at 60° C. with addition of 40 ppm of dibutyltin dilaurate until it was no longer possible to observe any isocyanate band in the IR spectrum. Subsequently, 51.3 g (0.231 mol) of isophorone diisocyanate were rapidly added dropwise and prepolymerization was effected until the theoretical NCO content of 0.68% had been reached. After addition of 81.2 g (0.231 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that was obtained had a viscosity of 21 200 mPas and a color number of 22 APHA.

### Example 7 (According to the Invention)

In a 2 l sulfonation flask with lid, stirrer, thermometer and nitrogen flow, 1349.7 g (0.16 mol) of a propylene glycol with an OH number of 13.3 (Acclaim® Polyol 8200 N from Covestro Deutschland AG; Leverkusen, Germany) were prepolymerized with 51.3 g (0.231 mol) of isophorone diisocyanate and 18.9 g (0.089 mol) of 3-isocyanatopropyltrimethoxysilane (Geniosil® GF 40 from Wacker

Chemie AG; Munich, Germany) at 60° C. with addition of 40 ppm of dibutyltin dilaurate until the theoretical NCO content of 0.68% had been reached. Subsequently, 81.2 g (0.231 mol) of diethyl N-(3-trimethoxysilylpropyl)aspartate (prepared according to EP-A 596 360, example 5) were rapidly added dropwise and the mixture was stirred until it was no longer possible to observe any isocyanate band in the IR spectrum. The polyurethane prepolymer having alkoxysilyl end groups that was obtained had a viscosity of 20 200 mPas and a color number of 18 APHA.

### Example 8 (Comparative Example)

In a 2 l sulfonation flask with lid, stirrer, thermometer and nitrogen flow, 1349.7 g (0.16 mol) of a propylene glycol with an OH number of 13.3 (Acclaim® Polyol 8200 N, Covestro Deutschland AG; Leverkusen, Germany) were stirred with 18.0 g (0.08 mol) of 3-isocyanatopropyltrimethoxysilane (Geniosil® GF 40, Wacker Chemie AG; Munich, Germany) at 60° C. with addition of 40 ppm of dibutyltin dilaurate until it was no longer possible to observe any isocyanate band in the IR spectrum. Subsequently, 53.3 g (0.24 mol) of isophorone diisocyanate were rapidly added dropwise and prepolymerization was effected until the theoretical NCO content of 0.68% had been reached. After addition of 84.3 g (0.24 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that was obtained had a viscosity of 23 500 mPas and a color number of 28 APHA.

### Example 9 (According to the Invention)

In a 2 l sulfonation flask with lid, stirrer, thermometer and nitrogen flow, 1349.7 g (0.16 mol) of a propylene glycol with an OH number of 13.3 (Acclaim® Polyol 8200 N, Covestro Deutschland AG; Leverkusen, Germany) were prepolymerized with 53.3 g (0.24 mol) of isophorone diisocyanate and 18.0 g (0.08 mol) of 3-isocyanatopropyltrimethoxysilane (Geniosil® GF 40, Wacker Chemie AG; Munich, Germany) at 60° C. with addition of 40 ppm of dibutyltin dilaurate until the theoretical NCO content of 0.68% had been reached. Subsequently, 84.3 g (0.24 mol) of diethyl N-(3-trimethoxysilylpropyl)aspartate (prepared according to EP-A 596 360, example 5) were rapidly added dropwise and the mixture was stirred until it was no longer possible to observe any isocyanate band in the IR spectrum. The polyurethane prepolymer having alkoxysilyl end groups that is obtained has a viscosity of 20 900 mPas and a color number of 24 APHA.

### Example 10 (Comparative Example)

In a 2 l sulfonation flask with lid, stirrer, thermometer and nitrogen flow, 1349.7 g (0.16 mol) of a propylene glycol with an OH number of 13.3 (Acclaim® Polyol 8200 N from Covestro Deutschland AG; Leverkusen, Germany) were stirred with 6.7 g (0.03 mol) of 3-isocyanatopropyltrimethoxysilane (Geniosil® GF 40 from Wacker Chemie AG; Munich, Germany) at 60° C. with addition of 40 ppm of dibutyltin dilaurate until it was no longer possible to observe any isocyanate band in the IR spectrum. Subsequently, 63.0 g (0.28 mol) of isophorone diisocyanate were rapidly added dropwise and prepolymerization was effected until the theoretical NCO content of 0.85% had been reached. After addition of 98.4 g (0.28 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that was obtained had a viscosity of 34 900 mPas and a color number of 18 APHA.

### Example 11 (According to the Invention)

In a 2 sulfonation flask with lid, stirrer, thermometer and nitrogen flow, 1349.7 g (0.16 mol) of a propylene glycol with an OH number of 13.3 (Acclaim® Polyol 8200 N, Covestro Deutschland AG; Leverkusen, Germany) were prepolymerized with 63.0 g (0.28 mol) of isophorone diisocyanate and 6.7 g (0.03 mol) of 3-isocyanatopropyltrimethoxysilane (Geniosil® GF 40, Wacker Chemie AG; Munich, Germany) at 60° C. with addition of 40 ppm of dibutyltin dilaurate until the theoretical NCO content of 0.85% had been reached. Subsequently, 98.4 g (0.28 mol) of diethyl N-(3-trimethoxysilylpropyl)aspartate (prepared according to EP-A 596 360, example 5) were rapidly added dropwise and the mixture was stirred until it was no longer possible to observe any isocyanate band in the IR spectrum. The polyurethane prepolymer having alkoxysilyl end groups that was obtained had a viscosity of 29 200 mPas and a color number of 14 APHA.

### Example 12 (Comparative Example)

In a 2 l sulfonation flask with lid, stirrer, thermometer and nitrogen flow, 1369.6 g (0.16 mol) of a propylene glycol with an OH number of 13.2 (Acclaim® Polyol 8200 N, Covestro Deutschland AG; Leverkusen, Germany) were stirred with 34.2 g (0.16 mol) of 3-isocyanatopropyltrimethoxysilane (Geniosil® GF 40, Wacker Chemie AG; Munich, Germany) at 60° C. with addition of 120 ppm of the Tyzor® IBAY titanium catalyst (abcr GmbH, Karlsruhe, Germany) until it was no longer possible to observe any isocyanate band in the IR spectrum. Subsequently, 35.9 g (0.16 mol) of isophorone diisocyanate were rapidly added dropwise and prepolymerization was effected until the theoretical NCO content of 0.47% had been reached. After addition of 56.2 g (0.16 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that is obtained has a viscosity of 15 050 mPas and a color number of 36 APHA.

### Example 13 (According to the Invention)

In a 2 l sulfonation flask with lid, stirrer, thermometer and nitrogen flow, 1369.6 g (0.16 mol) of a propylene glycol with an OH number of 13.2 (Acclaim® Polyol 8200 N, Covestro Deutschland AG; Leverkusen, Germany) were prepolymerized with 35.9 g (0.16 mol) of isophorone diisocyanate and 34.2 g (0.16 mol) of 3-isocyanatopropyltrimethoxysilane (Geniosil® GF 40, Wacker Chemie AG; Munich, Germany) at 60° C. with addition of 120 ppm of the Tyzor® IBAY titanium catalyst (abcr GmbH, Karlsruhe, Germany) until the theoretical NCO content of 0.47% had been reached. Subsequently, 56.2 g (0.16 mol) of diethyl N-(3-trimethoxysilylpropyl)aspartate (prepared according to EP-A 596 360, example 5) were rapidly added dropwise and the mixture was stirred until it was no longer possible to observe any isocyanate band in the IR spectrum. The polyurethane prepolymer having alkoxysilyl end groups that was obtained had a viscosity of 13 700 mPas and a color number of 30 APHA.

### Example 14 (Comparative Example)

In a 2 l sulfonation flask with lid, stirrer, thermometer and nitrogen flow, 1369.6 g (0.16 mol) of a propylene glycol with an OH number of 13.2 (Acclaim® Polyol 8200 N, Covestro Deutschland AG; Leverkusen, Germany) were stirred with 34.2 g (0.16 mol) of 3-isocyanatopropyltrimethoxysilane (Geniosil® GF 40, Wacker Chemie AG; Munich, Germany) at 60° C. with addition of 120 ppm of Yb(acac)₃ (abcr GmbH, Karlsruhe, Germany) until it was no longer possible to observe any isocyanate band in the IR spectrum. Subsequently, 35.9 g (0.16 mol) of isophorone diisocyanate was rapidly added dropwise and prepolymerization was effected until the theoretical NCO content of 0.47% had been reached. After addition of 56.2 g (0.16 mol) of diethyl N-(3-trimethoxysilylpropyl)aspartate (prepared according to EP-A 596 360, example 5), the mixture was stirred until it was no longer possible to observe any isocyanate band in the IR spectrum. The polyurethane prepolymer having alkoxysilyl end groups that was obtained had a viscosity of 16 500 mPas and a color number of 16 APHA.

### Example 15 (According to the Invention)

In a 2 l sulfonation flask with lid, stirrer, thermometer and nitrogen flow, 1369.6 g (0.16 mol) of a propylene glycol with an OH number of 13.2 (Acclaim® Polyol 8200 N, Covestro Deutschland AG; Leverkusen, Germany) were prepolymerized with 35.9 g (0.16 mol) of isophorone diisocyanate and 34.2 g (0.16 mol) of 3-isocyanatopropyltrimethoxysilane (Geniosil® GF 40, Wacker Chemie AG; Munich, Germany) at 60° C. with addition of 120 ppm of Yb(acac)₃ (abcr GmbH, Karlsruhe, Germany) until the theoretical NCO content of 0.47% had been reached. Subsequently, 56.2 g (0.16 mol) of diethyl N-(3-trimethoxysilylpropyl)aspartate (prepared according to EP-A 596 360, example 5) were rapidly added dropwise and the mixture was stirred until it was no longer possible to observe any isocyanate band in the IR spectrum. The polyurethane prepolymer having alkoxysilyl end groups that was obtained had a viscosity of 16 000 mPas and a color number of 14 APHA.

1.-17. (canceled)

18. A process for preparing a mixed silane-terminated polymer by
a) simultaneously reacting the hydroxyl groups of a polyol component A) with at least one diisocyanate B) and at least one isocyanatosilane C) in the presence of at least one catalyst D), and
b) subsequently reacting the free NCO groups of the reaction product from step a) with an aminosilane E).

19. The process as claimed in claim 18, wherein the polyol component A) is a polyether polyol having a number-average molecular weight in a range from 3000 to 24 000 g/mol.

20. The process as claimed in claim 18, wherein the polyol component A) is a polyether polyol having a number-average molecular weight of 5000 to 16 000 g/mol.

21. The process as claimed in claim 18, wherein the polyol component A) is a polyether polyol based on polypropylene oxide.

22. The process as claimed in claim 18, wherein the diisocyanate B) used is an aliphatic, cycloaliphatic or araliphatic diisocyanate or mixtures thereof.

23. The process as claimed in claim 18, wherein the diisocyanate B) is selected from the group consisting of 1,6-diisocyanatohexane, 1-isocyanato-3,3,5-trimethyl-5-isocyanatomethylcyclohexane, hexahydrotolylene 2,4-diisocyanate, hexahydrotolylene 2,6-diisocyanate, tolylene 2,4- diisocyanate, tolylene 2,6-diisocyanate, and mixtures thereof.

24. The process as claimed in claim 18, wherein the diisocyanate B) used is 1-isocyanato-3,3,5-trimethyl-5-isocyanatomethylcyclohexane (isophorone diisocyanate).

25. The process as claimed in claim 18, wherein the isocyanatosilane C) is a compound of formula (II) 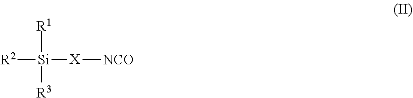
in which
R¹, R² and R³ independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, with the proviso that at least one of the radicals R¹, R² and R³ is joined to the silicon atom via an oxygen atom, and
X is a linear or branched organic radical having up to 6 carbon atoms.

26. The process as claimed in claim 18, wherein the isocyanatosilane C) used is 3-isocyanatopropyltrimethoxysilane.

27. The process as claimed in claim 18, wherein the aminosilane E) is a compound of formula (VIII) 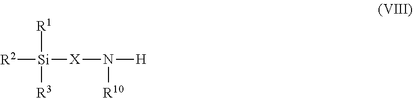
in which R¹, R², R³ and X have the definition given in claim 25 and
R¹⁰ is hydrogen, a saturated or unsaturated, linear or branched, aliphatic or cycloaliphatic or an optionally substituted aromatic or araliphatic radical having up to 18 carbon atoms or a radical of the formula 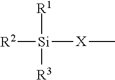
in which R¹, R², R³ and X have the definition given above.

28. The process as claimed in claim 18, wherein the aminosilane E) is a compound of formula (IX) 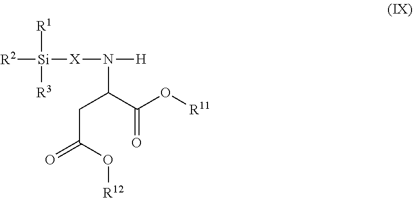
in which
R¹, R² and R³ have the definition given in claim 25
X is a linear or branched organic radical having at least 2 carbon atoms and
R¹¹ and R¹² independently of one another are saturated or unsaturated, linear or branched, aliphatic or cycloaliphatic or aromatic organic radicals which have 1 to 18 carbon atoms, are substituted or unsubstituted and/or have heteroatoms in the chain.

29. The process as claimed in claim 18, wherein the amount of aminosilane E) is chosen such that there are 0.8 to 1.2 amino groups for each isocyanate group of the isocyanate- and silane-functional polymer formed in process step a).

30. The process as claimed in claim 18, wherein the reaction with the diisocyanate B) and the isocyanatosilane C) is conducted in the presence of an Sn-, Ti- or Yb-containing catalyst D).

31. The process as claimed in claim 18, wherein the catalyst D) is selected from Sn(II)-, Sn(IV)- and Yb(III)-containing compounds and an organotitanate of formula (VI) 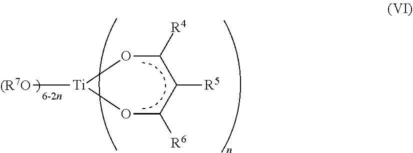
where
R⁴ is a hydrogen atom or a linear or branched alkyl group having 1 to 8 carbon atoms;
R⁵ is a hydrogen atom or a linear or branched alkyl group having 1 to 8 carbon atoms and optionally having heteroatoms;
R⁶ is a hydrogen atom or an alkyl group having 1 to 8 carbon atoms or a linear or branched alkoxy group having 1 to 8 carbon atoms;
R⁷ is a linear or branched alkyl radical having 2 to 20 carbon atoms; and
n is a value of 1 or 2.

32. The process as claimed in claim 18, wherein the catalyst is selected from an organotitanate and a β-diketonate compound of the transition metals scandium, lanthanum, cerium, praseodymium, neodymium, promethium, samarium, europium, gadolinium, terbium, dysprosium, holmium, erbium, thulium, ytterbium or lutetium.

33. The process as claimed in claim 18, wherein the molar amount of the isocyanatosilane C) used is in the range from 1 to 50 mol % and the molar amount of the diisocyanate B) used is accordingly in the range from 50 to 99 mol %, based on the number of hydroxyl groups of polyol A).

34. A method comprising utilizing the silane-terminated polymers prepared by the process of claim 18 as binders in coating compositions, sealants or as adhesives.
